(19) United States
(12) Patent Application Publication
(10) Pub. No.: US 2018/0162007 A1
(43) Pub. Date: Jun. 14, 2018

(54) Power-Tool Cutting Device

(71) Applicant: Robert Bosch GmbH, Stuttgart (DE)

(72) Inventors: Uwe Engelfried, Ostfildern (DE); Petr Grulich, Kirchheim/Teck (DE)

(21) Appl. No.: 15/580,654

(22) PCT Filed: Jul. 4, 2016
(86) PCT No.: PCT/EP2016/065659

§ 371 Date: Dec. 7, 2017

(30) Foreign Application Priority Data
Jul. 27, 2015 (DE) 10 2015 214 163.2

(51) Int. Cl. B27B 17/04

(52) U.S. Cl. CPC B27B 17/04

(57) ABSTRACT

A power-tool cutting device includes at least one cutting strand, at least one guide unit configured to guide the cutting strand, and at least one deflecting unit. The guide unit together with the cutting strand forms a closed system. The deflecting unit is arranged on a drive-remote side of the guide unit and has at least one movably mounted deflecting element configured to deflect the cutting strand at least while the cutting strand revolves about the guide unit. The deflecting element includes at least one contact surface for an at least temporary contact with the cutting strand. The deflecting element is configured to be at least substantially free from an extension for engagement in the cutting strand.

### PRIOR ART

A power-tool cutting device having at least one cutting strand, having at least one guide unit for guiding the cutting strand, which guide unit, in particular together with the cutting strand, forms a closed system, and having at least one deflection unit which is arranged on a drive-remote side of the guide unit has already been proposed. In this case, the deflection unit comprises at least one movably mounted deflection element for deflecting the cutting strand at least during rotation of the cutting strand around the guide unit, which deflection element includes at least one contact surface for contacting the cutting strand at least temporarily. The deflection element comprises at least one continuation for engagement in the cutting strand and is realized, in particular, as a sprocket nose.

### DISCLOSURE OF THE INVENTION

The invention proceeds from a power-tool cutting device having at least one cutting strand, having at least one guide unit for guiding the cutting strand, which guide unit, in particular together with the cutting strand, forms a closed system, and having at least one deflection unit which is arranged on a drive-remote side of the guide unit and comprises at least one movably mounted deflection element for deflecting the cutting strand at least during a rotation of the cutting strand around the guide unit, which deflection element includes at least one contact surface for contacting the cutting strand at least temporarily.

It is proposed that the deflection element is realized at least substantially free of a continuation for engagement in the cutting strand. A “cutting strand” is to be understood here, in particular, as a unit which is provided for the purpose of eliminating, in a local manner, an atomic cohesion of a workpiece to be processed, in particular by means of mechanical cutting and/or by means of mechanical removal of workpiece particles of the workpiece. In a preferred manner, the cutting strand is provided for the purpose of separating the workpiece into at least two parts that are physically separated from one another and/or proceeding from a surface of the workpiece, cutting off and/or removing at least in part workpiece particles of the workpiece. In a particularly preferred manner, the cutting strand is moved in a rotating manner around the guide unit in at least one operating state, in particular along a circumferential direction of the guide unit of the power-tool cutting device. In a particularly preferred manner, the cutting strand is realized as a cutting chain. However, it is also conceivable for the cutting strand to comprise a different configuration that appears sensible to an expert, such as, for example, a configuration as a cutting belt on which multiple cutting strand segments of the cutting strand are arranged. In a preferred manner, the cutting strand, when viewed along a direction that extends at least substantially perpendicular to a cutting plane of the cutting strand, comprises a maximum dimension of less than 4 mm. In a particularly preferred manner, the cutting strand, when viewed along the direction that extends at least substantially perpendicular to the cutting plane of the cutting strand, comprises an at least substantially constant maximum dimension along an entire length of the cutting strand. In a preferred manner, the maximum dimension corresponds to a value from a value range of between 1 mm and 3 mm along the entire length of the cutting strand. The power-tool cutting device, when viewed along an entire extension of the power-tool cutting device, comprises an overall width which is less than 4 mm. The cutting strand is preferably provided for the purpose of generating a cutting gap which, when viewed along the direction that extends at least substantially perpendicular to the cutting plane of the cutting strand, comprises a maximum dimension of less than 4 mm.

A “guide unit” is to be understood here, in particular, as a unit which is provided for the purpose of exerting a constraint force on the cutting strand, at least in a direction perpendicular to the cutting direction of the cutting strand, in order to provide a possibility of movement of the cutting strand along the cutting direction, in particular along the circumferential direction of the guide unit. In a preferred manner, the guide unit comprises at least one guide element, in particular a guide groove, by means of which the cutting strand is guided. In a preferred manner, the cutting strand, when viewed in the cutting plane of the cutting strand, is guided along an entire rotation of the guide unit by the guide unit by means of the guide element, in particular the guide groove. A “cutting direction” is to be understood here, in particular, as a direction along which the cutting strand is moved for generating a cutting gap and/or for cutting and/or for removing workpiece particles of a workpiece to be processed in at least one operating state as a result of a driving force and/or a driving moment, in particular in the guide unit. The expression “provided” is to define here, in particular, specially designed and/or specially equipped. This includes an element and/or a unit being provided for a certain function and is to be understood, in particular, as the element and/or the unit fulfilling and/or carrying out said certain function in at least one application state and/or operating state.

The term “closed system” is to define here, in particular, a system which includes at least two components which, with the system in a removed state from a system that is superordinate to the system, such as, for example, the portable power tool, maintain a functionality by means of interaction and/or which are captively connected together in the removed state. In a preferred manner, the at least two components of the closed system are connected together for a user in an at least substantially non-releasable manner. “In an at least substantially non-releasable manner” is to be understood here, in particular, as a connection between at least two components which are only separable from one another with the assistance of cutting tools, such as, for example, a saw, in particular a mechanical saw etc. and/or chemical separating means, such as, for example, solvents etc.

A “drive-remote side of the guide unit” is to be understood here, in particular, as a side of the guide unit which, with reference to a center plane of the guide unit which extends at least substantially perpendicular to the cutting plane of the cutting strand, faces away from a side of the guide unit at which a driving force is introduced to a drive of the cutting strand. A torque-transmitting element of the portable power tool preferably engages in the guide unit in a manner already known to an expert to introduce a driving force to a drive of the cutting strand. However, it is also conceivable for the power-tool cutting device to comprise a torque-transmitting element which is mounted in the guide unit and is connectable to an output element of the portable power tool to introduce a driving force to a drive of the cutting strand. The center plane preferably runs at least substantially perpendicular to a longitudinal axis of the guide unit. In a preferred manner, the center plane, when viewed along a direction which extends at least substantially perpendicular to the center plane, is at at least identical distances to two remote ends of the guide unit. In particular, the deflection element of the deflection unit, in particular in a state arranged on the coupling device of the portable power tool, is at a maximum distance to a movement axis of the torque-transmitting element which is less than 300 mm, in a preferred manner less than 150 mm and in a particularly preferred manner less than 75 mm. In a particularly preferred manner, the maximum distance is greater than 10 mm. In particular, the maximum distance comprises a value from the value range of between 20 mm and 220 mm. The deflection element of the deflection unit, in particular in a state arranged on the coupling device of the portable power tool, is at a maximum distance to the movement axis of the torque-transmitting element, which corresponds to at least 80% of a maximum extension of the guide unit along its longitudinal axis. The torque-transmitting element is provided, in particular, for the purpose of transmitting a driving force of a drive unit of the portable power tool to the cutting strand. The torque-transmitting element is preferably connected directly or indirectly to a motor shaft of the drive unit. The movement axis of the torque-transmitting element, in particular in a state arranged on the coupling device of the portable power tool, runs at least substantially perpendicular to the cutting plane of the cutting strand. In a preferred manner, the deflection element is rotatably mounted. In particular, the deflection element comprises a movement axis which extends at least substantially perpendicular to the cutting plane of the cutting strand. In a preferred manner, the movement axis of the deflection element, in particular in a state arranged on the coupling device of the portable power tool, extends at least substantially parallel to the movement axis of the torque-transmitting element. It is equally conceivable for the deflection element to be mounted additionally in another manner that appears sensible to an expert, such as, for example, a linearly movable bearing arrangement in order to be able to be used additionally as a clamping element for clamping the cutting strand, or a combination of a linear and a rotatable bearing arrangement. The deflection element preferably comprises a recess, into which a bearing element of the deflection unit is insertable. It is equally conceivable for the deflection element to be realized integrally with the bearing element and to be movably mounted in a bearing recess of the guide unit. The deflection element preferably deflects the cutting strand when the cutting strand is moved relative to the guide unit at least substantially by more than 10°, in a preferred manner by more than 45° and in a particularly preferred manner by less than 200°. In addition, it is conceivable for the deflection unit to include at least a number of movably mounted deflection elements that deviates from one, which are provided together to deflect the cutting strand at least during rotation of the cutting strand around the guide unit.

“Contacting the cutting strand at least temporarily” is to be understood here, in particular, at least when the cutting strand is arranged on the guide unit, as the cutting strand being abuttable against the deflection element or being movable into contact with said deflection element and/or, when the cutting strand rotates around the guide unit, at least one cutting strand segment of the cutting strand touching the deflection element at least for a short time. In particular, the contact surface of the deflection element is formed from at least one hardened material. It is equally conceivable for the contact surface, as an alternative to this or in addition to it, to be treated by means of a different method which appears sensible to an expert in order to make possible at least one advantageous contact characteristic with the cutting strand. The contact surface of the deflection element is preferably aligned at least substantially perpendicular to the cutting plane of the cutting strand. In particular, at least one cutting strand segment of the cutting strand is abuttable against the contact surface of the deflection element, in a preferred manner at least the cutting strand segment of the cutting strand is abuttable against the contact surface of the deflection element with a contact area of the cutting strand segment which is provided for this purpose. In a preferred manner, the contact surface of the deflection element forms an outside surface of the deflection element.

“Realized free of a continuation for engagement in the cutting strand” is to be understood here, in particular, as at least one maximum continuation, in particular all continuations, of the deflection element, which is/are aligned at least substantially transversely to the movement axis of the deflection element, comprises/comprise a maximum extension of less than 5 mm, in a preferred manner of less than 1 mm and in a particularly preferred manner of less than 0.1 mm, in particular proceeding from an outside surface of the deflection element which is at a smallest distance to the movement axis of the deflection element. In a preferred manner, the deflection element is realized substantially free of teeth. The surface of the deflection element preferably comprises a maximum roughness of less than 500 μm, in a preferred manner less than 200 μm and in a particularly preferred manner of less than 100 μm. It is equally conceivable for the deflection element to comprise at least substantially a corrugated surface. As a result of the configuration according to the invention of the power-tool cutting device, it is advantageously possible to keep friction at the deflection unit and at the cutting strand low. In addition, development of heat at the deflection unit and at the cutting strand can be kept low. In addition, in an advantageous manner, a reduction in wear both of the deflection unit and of the cutting strand can be achieved and a probability of the cutting strand being blocked when rotating around the guide unit can be consequently kept low. In an advantageous manner, compared to the prior art, the cutting strand can be more tightly stretched and/or a high cutting performance can be achieved at the same driving power of the drive unit for a movement of the cutting strand. In addition, costs can be saved in an advantageous manner during the production of the power-tool cutting device according to the invention. Time and consequently costs can also be saved in an advantageous manner during the mounting of the cutting strand on the guide unit. In addition, in dependence on a strength of friction forces between the cutting strand and the contact surface of the deflection element, an advantageous changeover between a sliding of the cutting strand on the contact surface of the deflection element and a simultaneous movement of cutting strand and deflection element can be achieved.

To fulfill the inventive idea, it is also conceivable in an alternative configuration of the power-tool cutting device for the power-tool cutting device to include at least one cutting strand, at least one guide unit for guiding the cutting strand, which guide unit, in particular together with the cutting strand, forms a closed system, and at least one deflection unit which is arranged on a drive-remote side of the guide unit and comprises at least one movably mounted deflection element for deflecting the cutting strand at least during rotation of the cutting strand around the guide unit, which deflection element includes at least one contact surface of the deflection element, it being proposed that the deflection element is mounted at least substantially free of a roller bearing. The alternative power-tool cutting device is to be seen, in particular, independently of the power-tool cutting device already described. In particular, the deflection element is mounted at least substantially free of roller elements, such as, for example, balls, barrels, needles, cylinders or the like. By means of the configuration according to the invention, additional costs can be saved in an advantageous manner during the production of the power-tool cutting device according to the invention. Mounting expenditure when mounting the deflection element in the guide unit can also be reduced in an advantageous manner.

It is further proposed that the deflection element is realized as a deflection disk. The deflection element preferably comprises at least substantially a maximum thickness of less than 5 mm, in a preferred manner of less than 2 mm and in a particularly preferred manner of less than 1 mm. The deflection element is preferably at least substantially at a maximum distance to an outer border of the guide unit of less than 3 mm, in a preferred manner of less than 2 mm and in a particularly preferred manner of less than 1 mm. In a particularly preferred manner, the maximum distance to the outer border is greater than 0.1 mm. The contact surface of the deflection element is preferably provided for the purpose of making it possible for the cutting strand to slide on the contact surface of the deflection element when rotating around the guide unit, in particular at least the cutting strand segment of the cutting strand can slide on the contact surface of the deflection element by way of the contact area provided for this purpose. A deflection element that is cost-efficient to produce can be realized in an advantageous manner by means of the configuration according to the invention of the power-tool cutting device.

It is further proposed that the deflection element comprises an at least substantially circular configuration. “An at least substantially circular configuration of the deflection element” is to be understood here, in particular, as a configuration of the deflection element where an outside contour of the deflection element, when viewed in a plane which extends at least substantially perpendicular to the movement axis of the deflection element, comprises a form of a circle, which has a maximum deviation from an ideal circle of no more than 20%, or which is almost in the form of an ellipse, a large and a small half-axis of the ellipse being at a maximum ratio of less than 2:1, in a preferred manner less than 3:2 and in a particularly preferred manner less than 4:3. In particular, the deflection disk comprises at least substantially a maximum diameter of less than 20 mm, in a preferred manner of less than 10 mm and in a particularly preferred manner of less than 5 mm. The diameter of the deflection disk is, in particular, at least substantially 20 times, in a preferred manner 10 times and in a particularly preferred manner 5 times the thickness of the deflection disk. A structurally simple configuration to make possible a large sliding surface between the cutting strand and the deflection element can be realized in an advantageous manner by means of the configuration according to the invention.

It is additionally proposed that the contact surface of the deflection element is realized at least in part in a friction-reducing manner. The contact surface of the deflection element is preferably at least substantially surface-treated. The contact surface of the deflection element comprises, in a preferred manner, at least substantially a chemical, physical or another surface treatment which appears sensible to an expert. The contact surface of the deflection element preferably includes at least substantially a partially chemical, physical or other coating for friction reduction which appears sensible to an expert. In particular, the contact surface of the deflection element is realized with surface-structuring, in a preferred manner with micro-structuring and in a particularly preferred manner with nano-structuring. The deflection element is preferably formed from a material which makes possible an at least substantially friction-reducing configuration of the deflection element, such as, for example, graphite or the like. Heating of the deflection element and of the cutting strand can be reduced and wear on the deflection element and the cutting strand can be further minimized as a result of the configuration according to the invention of the power-tool cutting device. In addition, a long service life of the deflection element and of the cutting strand can be advantageously achieved.

It is further proposed that the deflection unit includes at least one further deflection unit which is surrounded at least in part by the deflection element. The further deflection element is preferably surrounded at least substantially completely by the deflection element along a rotation direction of the deflection element. The further deflection element is mounted with the deflection element, in a preferred manner, at least substantially concentrically. A reduction in friction influences on the deflection element can be achieved in an advantageous manner by means of the configuration according to the invention of the power-tool cutting device. The cutting strand can be advantageously deflected in a friction-reduced manner when rotating around the guide unit.

It is further proposed that the deflection unit includes at least one further deflection element which is movably mounted and comprises a sliding surface which is provided for the purpose of making possible a sliding movement of the deflection element relative to the deflection element. The further deflection element is preferably movably mounted, in particular rotatably mounted. It is equally conceivable for the further deflection element to be mounted so as to be additionally linearly movable. In a preferred manner, the further deflection element is movable relative to the deflection element and/or to the cutting strand. In particular, the sliding surface of the further deflection element extends at least substantially perpendicular to the cutting plane of the cutting strand. The sliding surface of the further deflection element forms, in particular, an outside surface of the further deflection element. In a particularly preferred manner, the sliding surface is realized at least substantially in a friction-reducing manner. In this regard, the sliding surface comprises at least substantially all the features of the contact surface of the deflection element, such as, for example, a friction-reducing coating etc. By means of the configuration according to the invention of the power-tool cutting device, the deflecting element can be advantageously mounted in a friction-optimized manner by the further deflection element being able to serve as a rolling element. The friction between the deflection element and the further deflection element and consequently the development of heat between said two elements can advantageously be kept low in order, in a particularly advantageous manner, to reduce wear on the deflection element and on the further deflection element.

It is further proposed that the guide unit comprises an inlet region for the cutting strand which adjoins the deflection element at least substantially and an outlet region for the cutting strand which adjoins the deflection element at least substantially, the inlet and outlet regions being realized differently. An “inlet region” is to be understood here, in particular, as a region of the guide unit in which the cutting strand, when rotating around the guide unit, runs toward the deflection element, in particular when viewed in a region of the guide unit at a distance to the deflection element which is less than 10 mm. An “outlet region” is to be understood here, in particular, as a region of the guide unit in which the cutting strand, when rotating around the guide unit, runs away from the deflection element, in particular when viewed in a region of the guide unit at a distance to the deflection element which is less than 10 mm. When rotating around the guide unit, the cutting strand is moved in the inlet region preferably at least substantially in the opposite direction to the outlet region. The inlet region is preferably configured in such a manner that at least one outer line of the inlet region runs at least substantially in the direction of an outside extent of the deflection element and/or is curved at least substantially in the direction of the outside extent of the deflection element and approaches the same. In particular, the outer line of the inlet region runs at least approximately in the tangential direction of the deflection element. The outlet region is preferably at least substantially at a larger distance relative to the deflection element compared to the inlet region. The outlet region is preferably configured in such a manner that at least one outer line of the outlet region runs at least substantially in the direction of movement axis of the deflection element and/or is curved at least substantially in the direction of the movement axis of the deflection element. The outlet region comprises a larger radius of curvature compared to the inlet region. A different realization of inlet region and outlet region can be achieved, in particular, as a result of the guide unit comprising at least one guide element which is realized asymmetrically to the longitudinal axis. It is also conceivable for the guide unit to comprise at least two guide elements which are realized variously, or for the guide unit to comprise at least more than two guide elements which are realized variously. Secure guiding of the cutting strand when rotating around the guide unit toward the deflection element and away from the deflection element can be achieved in an advantageous manner. The likelihood of the cutting strand getting caught and consequently a probability of the cutting strand being blocked can advantageously be kept small. In addition, the cutting strand rotating reliably around the guide unit can be made possible.

It is advantageously proposed that that the guide unit comprises a longitudinal axis and at least one guide element which is realized asymmetrically to the longitudinal axis and delimits a receiving region for the deflection element. It is equally conceivable for the guide unit to comprise more than one guide element, which are realized asymmetrically to the longitudinal axis and delimit a receiving region for the deflection element. In particular, the longitudinal axis of the guide unit runs at least substantially in the cutting plane of the cutting strand and at least substantially perpendicular to the center plane of the guide unit. The guide element of the guide unit includes, on an end of the guide element facing the deflection element, at least substantially the inlet region and/or the outlet region. In an alternative configuration of the power-tool cutting device, it is conceivable for the guide element to be realized, in particular, with multiple parts, in a preferred manner with three parts and in a particularly preferred manner with two parts. Optimum kinematics of the cutting strand, when rotating around the guide unit, toward the deflection unit and away from the deflection unit can be achieved in a particularly simple and cost-efficient manner.

It is further proposed that the guide unit comprises at least one guide element which comprises at least one transfer continuation which is provided for the purpose of making possible an at least substantially seamless transition of the cutting strand from the guide element to the deflection element when the cutting strand moves relative to the guide element. The transfer continuation extends at least substantially tangentially in the direction of the outside extent of the deflection element. The transfer continuation is, in particular, at a maximum distance to the deflection element of less than 3 mm, in a preferred manner less than 2 mm and in a particularly preferred manner of less than 1 mm. A substantially uninterrupted guiding of the cutting strand when rotating around the guide unit can be achieved in an advantageous manner toward the deflection element. Reliable guiding of the cutting strand segments of the cutting strand can be made possible in a particularly advantageous manner toward the deflection element. In addition, it can be advantageously achieved that the cutting strand segments, when rotating around the guide unit, are introduced at least substantially tangentially to the deflection element toward the deflection element. Additionally, proposed is a power tool system having at least one power-tool cutting device according to the invention and having at least one portable power tool which comprises at least one coupling device for positive locking and/or friction locking coupling with the power-tool cutting device according to the invention. A “portable power tool” is to be understood here, in particular, as a power tool, in particular a hand-held power tool, which can be transported by an operator without a transporting machine. The portable power tool comprises, in particular, a weight which is lighter than 40 kg, in a preferred manner lighter than 10 kg and in a particular preferred manner lighter than 5 kg. In an advantageous manner, it is possible to realize a power tool system where friction forces at the deflection unit and at the cutting strand are reduced and consequently heat development at the deflection unit and at the cutting strand is kept low. In addition, a power tool system can be made possible advantageously where wear, both on the deflection unit and on the cutting strand, can be kept low and consequently blocking of the cutting strand when rotating around the guide unit can be avoided. In the case of the power tool system according to the invention, the cutting strand can be advantageously stretched more tightly compared to the prior art and/or increased cutting performance can be achieved at the same driving power of a drive unit for moving the cutting strand. In particular, friction and wear can be advantageously distributed between the deflection unit and the cutting strand. In addition, additional costs can be saved in an advantageous manner in the production of the power-tool cutting device according to the invention. Expenditure on mounting the guide unit can also be advantageously reduced.

The power-tool cutting device according to the invention and/or the power tool system according to the invention is/are not to be restricted in this connection to the above-described application and embodiment. In particular, the power-tool cutting device according to the invention and/or the power tool system according to the invention can comprise a number which deviates from the number of individual elements, components and units named herein for fulfillment of a method of operation described herein. In addition, values which are also situated within the named boundaries in the case of the value ranges specified in said disclosure are to apply as disclosed and as arbitrarily usable.

### DRAWING

Further advantages are produced from the following description of the drawing. Four exemplary embodiments of the invention are shown in the drawing. The drawing, the description and the claims include numerous features in combination. The expert will also look at the features individually in an expedient manner and combine them to form sensible further combinations.

In which:

FIG. 1 shows a schematic representation of a portable power tool according to the invention having a power-tool cutting device according to the invention,

FIG. 2 shows a schematic representation of a view of a detail of a first exemplary embodiment of a power-tool cutting device according to the invention,

FIG. 3 shows a schematic representation of a view of a detail of a second exemplary embodiment of a power-tool cutting device according to the invention,

FIG. 4 shows a schematic representation of a view of a detail of a third exemplary embodiment of a power-tool cutting device according to the invention and

FIG. 5 shows a schematic representation of a view of a detail of a fourth exemplary embodiment of a power-tool cutting device according to the invention.

### DESCRIPTION OF THE EXEMPLARY EMBODIMENTS

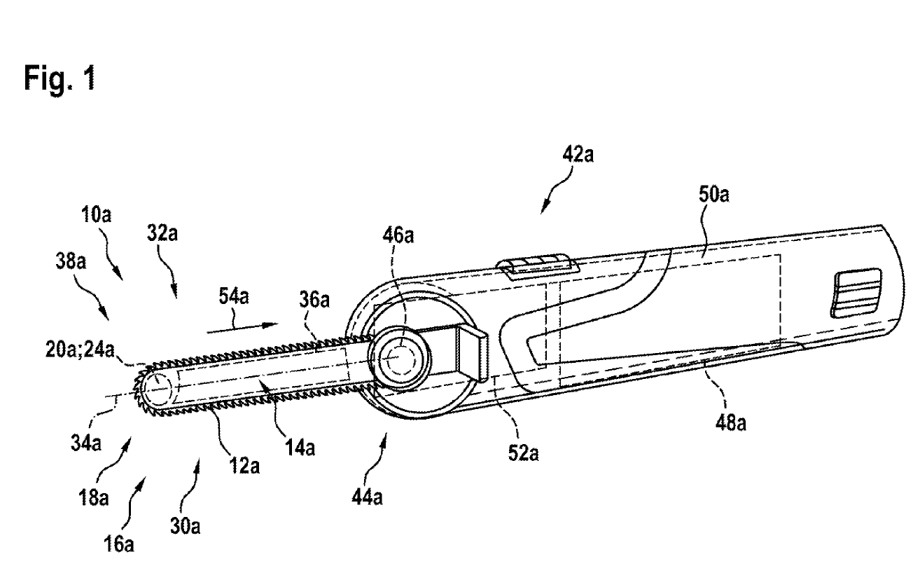

FIG. 1 shows a portable power tool 42a having a power-tool cutting device 10a according to the invention which together form a power tool system. The portable power tool 42a comprises at least one coupling device 44a for positive locking and/or friction locking coupling with the power-tool cutting device 10a. The coupling device 44a can be realized as a bayonet closure, a snap lock and/or as a different coupling device which appears sensible to an expert. The power-tool cutting device 10a or the portable power tool 42a comprises at least one torque-transmitting element 46a. The torque-transmitting element 46a can be realized as a toothed wheel, in particular as a pinion. The power-tool cutting device 10a includes at least one cutting strand 12a and at least one guide unit 14a for guiding the cutting strand 12a. The guide unit 14a together with the cutting strand 12a forms a closed system. The torque-transmitting element 46a is provided for transmitting a driving force of a drive unit 48a of the portable power tool 42a to the cutting strand 12a.

The portable power tool 42a comprises at least one power tool housing 50a which surrounds the drive unit 48a and a gear unit 52a of the portable power tool 42a. The drive unit 48a and the gear unit 52a are operatively connected together in a manner already known to an expert for generating a driving torque, which is transmittable to the power-tool cutting device 10a. The gear unit 52a is realized in a preferred manner as an angular gear. The drive unit 48a is realized in a preferred manner as an electric motor unit. However, it is also conceivable for the drive unit 48a and/or the gear unit 52a to comprise another configuration which appears sensible to an expert, such as, for example, a configuration of the gear unit 52a as a worm gear etc. The drive unit 48a is provided for the purpose of driving the cutting strand 12a of the power-tool cutting device 10a via the gear unit 52a in at least one operating state. The cutting strand 12a is moved in the guide unit 14a of the power-tool cutting device 10a along a cutting direction 54a of the cutting strand 12a in the guide unit 14a, in particular relative to the guide unit 14a.

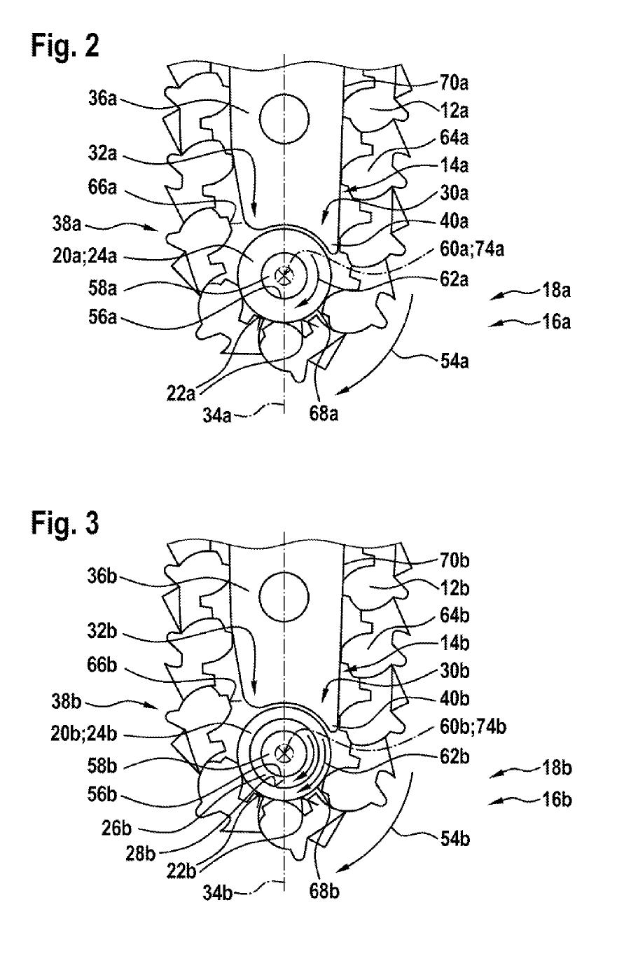

FIG. 2 shows a power-tool cutting device 10a according to the invention, in detail. The power-tool cutting device 10a includes a cutting strand 12a and a guide unit 14a for guiding the cutting strand 12a which, in particular, together with the cutting strand 12a, forms a closed system. The power-tool cutting device 10a includes at least one deflection unit 18a, which is arranged on a drive-remote side 16a of the guide unit 14a and comprises at least one movably mounted deflection element 20a for deflecting the cutting strand 12a at least during rotation of the cutting strand 12a around the guide unit 14a, which deflection element includes at least one contact surface 22a for contacting the cutting strand 12a at least temporarily. The deflection element 20a is realized at least substantially free of a continuation for engagement in the cutting strand 12a. In a preferred manner, the deflection element 20a, when viewed in a direction transversely to the movement axis 60a of the deflection element 20a, in particular when viewed transversely to a rotation axis 74a of the deflection element 20a, is realized at least substantially free of teeth. The deflection element 20a is mounted at least substantially free of a roller bearing. The deflection element 20a is realized as a deflection disk 24a. In said exemplary embodiment, the deflection element 20a comprises a recess 56a, into which a bearing element 58a of the deflection unit 18a is inserted to form a movable bearing arrangement of the deflection element 20a. The bearing element 58a is realized in the form of a bolt. The deflection element 20a is mounted so as to be rotatable about the bearing element 58a. The rotation axis 74a of the deflection element 20a runs at least substantially perpendicular to the cutting plane of the cutting strand 12a. A direction of rotation 62a of the deflection element 20a is at least substantially parallel to a cutting direction 54a of the cutting strand 12a. The deflection element 20a is arranged at least substantially symmetrically with reference to a longitudinal axis 34a of the guide unit 14a. It is equally conceivable for the deflection element 20a to be arranged in an alternative configuration at least substantially asymmetrically with reference to a longitudinal axis 34a. The deflection element 20a, when viewed along a direction perpendicular to the longitudinal axis 34a, comprises a diameter of at least substantially half the width of the guide unit 14a. The deflection element 20a comprises an at least substantially circular configuration. A diameter of the deflection element 20a, when viewed in a plane parallel to the cutting plane of the cutting strand 12a, comprises an at least substantially constant dimension in all directions. For contacting the cutting strand 12a at least temporarily, the deflection element 20a includes the contact surface 22a. The contact surface 22a is aligned at least substantially perpendicular to the cutting plane of the cutting strand 12a. The contact surface 22a, when viewed along the direction of rotation 62a of the deflection element 20a, runs at least substantially along an outer extent 68a of the deflection element 20a. The cutting strand 12a includes individual cutting strand segments 64a which, when put together, form the cutting strand 12a. The individual cutting strand segment 64a comprises a contact area 66a for contacting the deflection element 20a. The contact area 66a comprises a rounded configuration. The deflection element 20a and the individual cutting strand segment 64a can abut against one another at least substantially via the contact surface 22a and via the contact area 66a. The contact surface 22a is preferably provided such that the individual cutting strand segment 64a, with the contact area 66a provided for that purpose, can move parallel to the cutting plane of the cutting strand 12a at least substantially relative to the deflection disk 24a when rotating around the guide unit 14a. The contact surface 22a is realized at least in part in a friction-reducing manner. The guide unit 14a comprises an inlet region 30a for the cutting strand 12a which adjoins at least substantially the deflection element 20a and an outlet region 32a for the cutting strand 12a which adjoins at least substantially the deflection element 20a, the inlet and outlet regions being realized differently. The inlet region 30a is preferably configured in such a manner that at least one outer line 70a of the inlet region 30a runs at least substantially in the direction of the outer extent 68a of the deflection element 20a and/or is curved at least substantially in the direction of the outer extent 68a of the deflection element 20a and approaches the same. The outer line 70a of the inlet region 30a runs at least substantially in the tangential direction of the deflection element 20a. In particular, the outer line 70a approaches a tangent of the deflection element 20a. The outlet region 32a is at a greater distance relative to the deflection element 20a compared to the inlet region 30a. The guide unit 14a comprises at least one guide element 36a which is realized asymmetrically to the longitudinal axis 34a and which delimits a receiving region 38a for the deflection element 20a. It is equally conceivable for the guide unit 14a to comprise more than one guide element 36a, which are realized asymmetrically to the longitudinal axis 34a and which delimit a receiving region 38a for the deflection element 20a. The guide element 36a, on an end that faces the deflection element 20a, comprises a curvature which runs at least substantially parallel to the outer extent 68a of the deflection element 20a. The guide element 36a delimits the receiving region 38a for the deflection element 20a on one side by means of the end that faces the deflection element 20a. The guide element 36a comprises a transfer continuation 40a which is provided for the purpose of making possible, when the cutting strand 12a moves relative to the guide element 36a, an at least substantially seamless transition of the cutting strand 12a from the guide element 36a to the deflection element 20a. The transfer continuation 40a is arranged at least in part in the inlet region 30a. The transfer continuation 40a runs at least substantially tangentially in the direction of the outer extent 68a of the deflection element 20a. The guide element 36a forms the inlet region 30a and/or the outlet region 32a.

FIGS. 3 to 5 show further exemplary embodiments of the invention. The following descriptions and the drawings are limited substantially to the differences between the exemplary embodiments, it also being possible, in principle, to refer to the drawings and/or the description of the other exemplary embodiments, in particular of FIGS. 1 and 2, with reference to identically designated components, in particular with reference to components with identical reference signs. To differentiate between the individual exemplary embodiments of the invention, the letters a to d follow the respective reference signs in FIGS. 2 to 5. In the exemplary embodiments in FIGS. 3 to 5, the letter a is replaced by the letters b to d.

FIG. 3 shows a second exemplary embodiment of a power-tool cutting device 10b according to the invention in detail. In said exemplary embodiment, the deflection unit 18b includes at least one further deflection element 26b, which is surrounded at least in part by the deflection element 20b. The further deflection element 26b is movably mounted and comprises a sliding surface 28b which is provided for the purpose of making possible a sliding movement of the further deflection element 26b relative to the deflection element 20b. The further deflection element 26b is surrounded completely by the deflection element 20b along the direction of rotation 62b. The further deflection element 26b and the bearing element 58b are arranged in the recess 56b of the deflection element 20b. The deflection element 20b and the further deflection element 26b are mounted so as to be rotatable about the bearing element 58b. The further deflection element 26b is mounted with the deflection element 20b at least substantially concentrically. The further deflection element 26b and the deflection element 20b are arranged at least substantially symmetrically with reference to the longitudinal axis 34b. The further deflection element 26b is movable relative to the bearing element 58b, to the deflection element 20b and to the cutting strand 12b. The sliding surface 28b of the further deflection element 26b is arranged perpendicular to the cutting plane of the cutting strand 12b at a border of the further deflection element 26b that faces the deflection element 20b. The sliding surface 28b runs at least substantially parallel to the contact surface 22b for contacting the cutting strand 12b of the deflection element 20b at least temporarily. The sliding surface 28b is realized at least substantially in a friction-reducing manner. With regard to further features and functions of the power-tool cutting device 10b shown in FIG. 3, reference may be made to the description of the power-tool cutting device 10a shown in FIGS. 1 and 2.

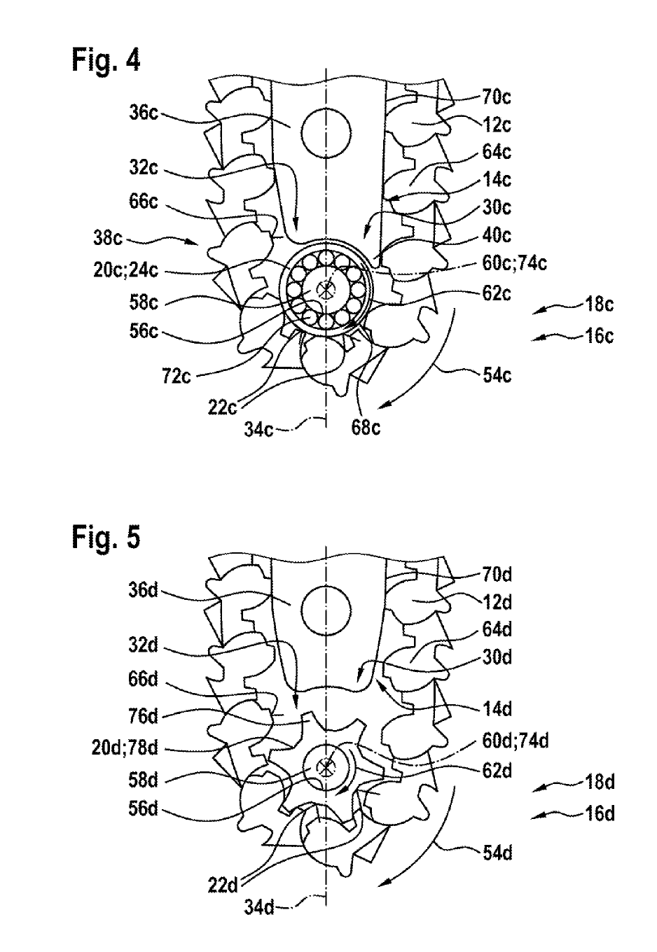

FIG. 4 shows a third exemplary embodiment of a power-tool cutting device 10c according to the invention in detail. The deflection element 20c is mounted on a roller bearing 72c of the deflection unit 18c. The roller bearing 72c includes rolling elements which are realized as balls in said exemplary embodiment. It is equally conceivable for the deflection element 20c, in an alternative exemplary embodiment, to be mounted in another manner which appears sensible to an expert, such as, for example, on cylindrical elements. With regard to further features and functions of the power-tool cutting device 10c shown in FIG. 4, reference may be made to the description of the power-tool cutting device 10a shown in FIGS. 1 and 2.

FIG. 5 shows a fourth exemplary embodiment of a power-tool cutting device 10d according to the invention in detail. The deflection element 20d comprises at least one continuation 76d for engagement in the cutting strand 12d. The deflection element 20d is mounted at least substantially free of a roller bearing. The deflection element 20d is realized in a star-shaped manner, in particular it is realized as a sprocket nose 78d or pinion. The contact surface 22d for contacting the cutting strand 12d at least temporarily runs at least substantially parallel to the contact area 66d of the individual cutting strand segments 64d. The deflection element 20d and the cutting strand 12d are moved together at least substantially homogeneously when rotating around the guide unit 14d by means of engagement of the continuation 76d in the cutting strand 12d. The outer line 70d of the inlet region 30d for the cutting strand 12d runs at least substantially in the direction of the bearing element 58d. The inlet region 30d for the cutting strand 12d and the outlet region 32d for the cutting strand 12d comprise at least substantially the same configuration. The guide element 36d is realized at least substantially symmetrically to the longitudinal axis 34d and delimits at least substantially the receiving region 38d for the deflection element 20d. The guide element 36d comprises a curvature on an end that faces the deflection element 20d. The guide element 36d delimits the receiving region 38d for the deflection element 20d at least substantially on one side by means of the end that faces the deflection element 20d. With regard to further features and functions of the power-tool cutting device 10d shown in FIG. 5, reference may be made to the description of the power-tool cutting device 10a shown in FIGS. 1 and 2.

1. A power-tool cutting device, comprising:
at least one cutting strand;
at least one guide unit configured to guide the cutting strand, the guide unit together with the cutting strand forming a closed system; and
at least one deflection unit arranged on a drive-remote side of the guide unit, the deflection unit including at least one movably mounted deflection element configured to deflect the cutting strand at least during rotation of the cutting strand around the guide unit,
wherein the deflection element includes at least one contact surface configured to at least temporarily contact the cutting strand, the deflection element realized at least substantially free of a continuation for engagement in the cutting strand.

2. The power-tool cutting device as claimed in claim 1, wherein the deflection element is configured as a deflection disk.

3. The power-tool cutting device as claimed in claim 1, wherein the deflection element comprises an at least substantially circular configuration.

4. The power-tool cutting device as claimed in claim 1, wherein the contact surface configured to contact the cutting strand of the deflection element at least temporarily is configured at least in part in a friction-reducing manner.

5. The power-tool cutting device as claimed in claim 1, wherein the deflection unit includes at least one further deflection unit surrounded at least in part by the deflection element.

6. The power-tool cutting device as claimed in claim 1, wherein the deflection unit includes at least one further deflection element which is movably mounted and comprises a sliding surface that is configured to provide a sliding movement of the further deflection element relative to the deflection element.

7. The power-tool cutting device as claimed in claim 1, wherein the guide unit comprises (i) an inlet region for the cutting strand which adjoins the deflection element at least substantially and (ii) an outlet region for the cutting strand which adjoins the deflection element at least substantially, the inlet region configured differently than the outlet region.

8. The power-tool cutting device as claimed in claim 1, wherein the guide unit comprises a longitudinal axis and at least one guide element which is configured asymmetrically to the longitudinal axis and delimits a receiving region for the deflection element.

9. The power-tool cutting device as claimed in claim 1, wherein the guide unit comprises at least one guide element which comprises at least one transfer continuation that is configured to provide an at least substantially seamless transition of the cutting strand from the guide element to the deflection element when the cutting strand moves relative to the guide element.

10. A power tool system, comprising:
at least one power-tool cutting device including:
at least one cutting strand,
at least one guide unit configured to guide the cutting strand, the guide unit together with the cutting strand forming a closed system, and
at least one deflection unit arranged on a drive-remote side of the guide unit, the deflection unit including at least one movably mounted deflection element configured to deflect the cutting strand at least during rotation of the cutting strand around the guide unit,
wherein the deflection element includes at least one contact surface configured to at least temporarily contact the cutting strand, the deflection element realized at least substantially free of a continuation for engagement in the cutting strand; and
at least one portable power tool which comprises at least one coupling device for one or more of positive locking and friction locking coupling with the power-tool cutting device.
